(19) United States
(12) Patent Application Publication
(10) Pub. No.: US 2017/0023796 A1
(43) Pub. Date: Jan. 26, 2017

(54) EYEGLASS TEMPLE OF COMPOSITE MATERIAL

(71) Applicant: Chun-Nan CHEN, Tainan (TW)

(72) Inventor: Chun-Nan CHEN, Tainan (TW)

(21) Appl. No.: 14/852,879

(22) Filed: Sep. 14, 2015

(30) Foreign Application Priority Data
Jul. 20, 2015 (TW) 104211658

(51) Int. Cl. G02C 5/18

(52) U.S. Cl. CPC G02C 5/18; G02C 2200/14

(57) ABSTRACT

An eyeglass temple of composite material mainly includes an aluminum-alloy made temple body and non-metallic material combined together. The temple body is form integral with a pivotal seat, molding projections, molding ornamental pieces and an elongated tail. The non-metallic material is injection molded on the aluminum-alloy temple body to form different senses of texture and further elevate practical value of the eyeglass temple of composite material.

### BACKGROUND OF THE INVENTION

1. Field of the Invention

This invention relates to an eyeglass temple of composite material, particularly to one having a temple body provided with a pivotal seat and formed with a three-dimensional surface and then molded together with non-metallic material to make up a composite-material eyeglass temple that has practicability and esthetic sense.

2. Description of the Prior Art

Generally, a frequently seen eyeglass temple has a metallic rod combined therein so that a wearer can conveniently adjust the angles of the eyeglass temple, but such a frequently seen metallic temple is traditional, monotonous and unable to satisfy nowadays consumers who pursuit novel and original design. Therefore, the conventional eyeglass temple is necessary to be ameliorated.

### SUMMARY OF THE INVENTION

The objective of this invention is to offer an eyeglass temple of composite material, practical in use and convenient in assembly.

The eyeglass temple of composite material in the present invention includes a temple body and non-metallic material combined together. The temple body made of aluminum-alloy and formed integrally has its front end provided with a pivotal seat, and a plurality of molding projections and recesses are provided at the rear side of the pivotal seat, and the temple body has another side extending to form an elongated tail. The non-metallic material is injection molded on the recesses and the elongated tail of the temple body, letting the molding projections and the non-metallic material form another kind of three-dimensional effect and practicability.

### BRIEF DESCRIPTION OF DRAWINGS

This invention will be better understood by referring to the accompanying drawings, wherein:

FIG. 1 is a perspective view of a first preferred embodiment of a temple body in the present invention;

FIG. 2 is a perspective view of the first preferred embodiment of an eyeglass temple of composite material in the present invention;

FIG. 3 is a cross-sectional view of the first preferred embodiment of an eyeglass temple of composite material in the present invention;

FIG. 4 is a perspective view of a second preferred embodiment of a temple body in the present invention; and

FIG. 5 is a perspective view of the second preferred embodiment of an eyeglass temple of composite material in the present invention.

### DETAILED DESCRIPTION OF THE PREFERRED EMBOIDMENT

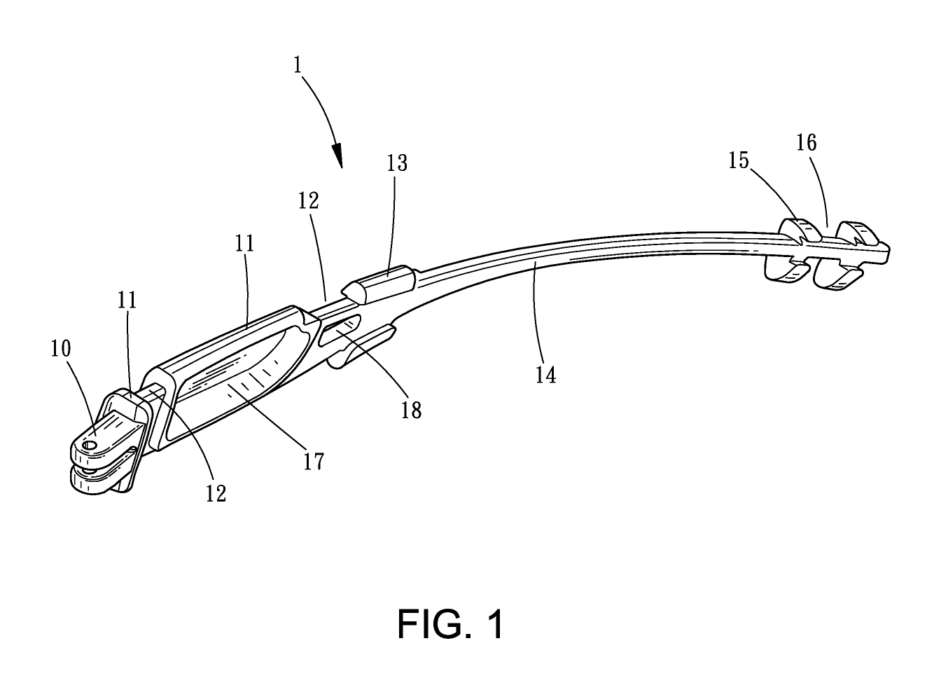

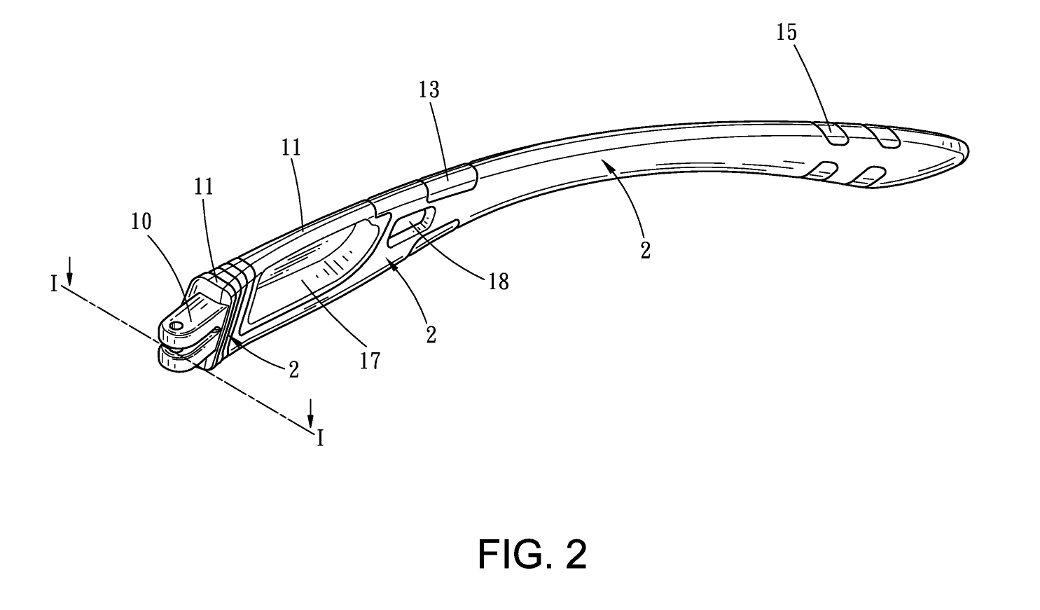

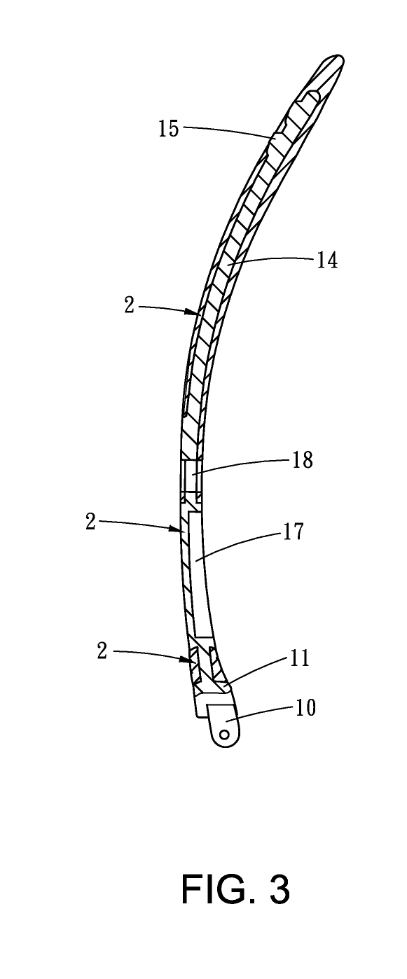

A first preferred embodiment of an eyeglass temple of composite material in the present invention, as shown in FIGS. 1-3, mainly includes a temple body 1 and non-metallic material 2 combined together. The temple body 1 is made of aluminum-alloy and formed by mold casting and specially processed for preventing rust and forming a shining surface. The temple body 1 is formed integrally and has its front end provided with a pivotal seat 10 having its rear side provided with a plurality of molding projections 11, recesses 12 and molding ornamental pieces 13. An elongated tail 14 is connected with the rear section of the molding ornamental pieces 13, and plural annular projections 15 and an annular groove 16 are provided at the rear end of the elongated tail 14. Further, one molding projection 11 is formed with a recessed groove 17, and a through hole 18 is bored under the recesses 12. After the temple body 1 is placed in an injection molding machine, the non-metallic material 2 is injection molded on the recesses 12, the elongated tail 14 and the annular groove 16 of the temple body 1. Thus, the molding projections 11 and the molding ornamental pieces 13 and the annular projections 15 are different from the recesses 12 and the elongated tail 14 and the annular groove 16 in material and hence, the eyeglass temple of composite material of this invention can show molding esthetic sense; wherein the non-metallic material 2 can be rubber, silica gel or the like.

Since the temple body 1 is formed with the recessed groove 17, the through hole 18 and the annular groove 16; therefore, when the aluminum-alloy temple body 1 is partially injection molded with the non-metallic material 2 to make up an eyeglass temple of composite material, the non-metallic material 2 can be tightly combined together with the temple body 1 and impossible to slide. Thus, the casting shaped temple body 1 is put into a mold to have the non-metallic material 2 injected on the temple body 1 and molded in shape; therefore, the non-metallic material 2 can be completely and firmly combined with the temple body 1, letting the eyeglass temple possess practicability and further enhancing esthetic sense and texture sense of the eyeglass temple of composite material via the combination of the exposed aluminum-alloy metallic sense with the non-metallic material.

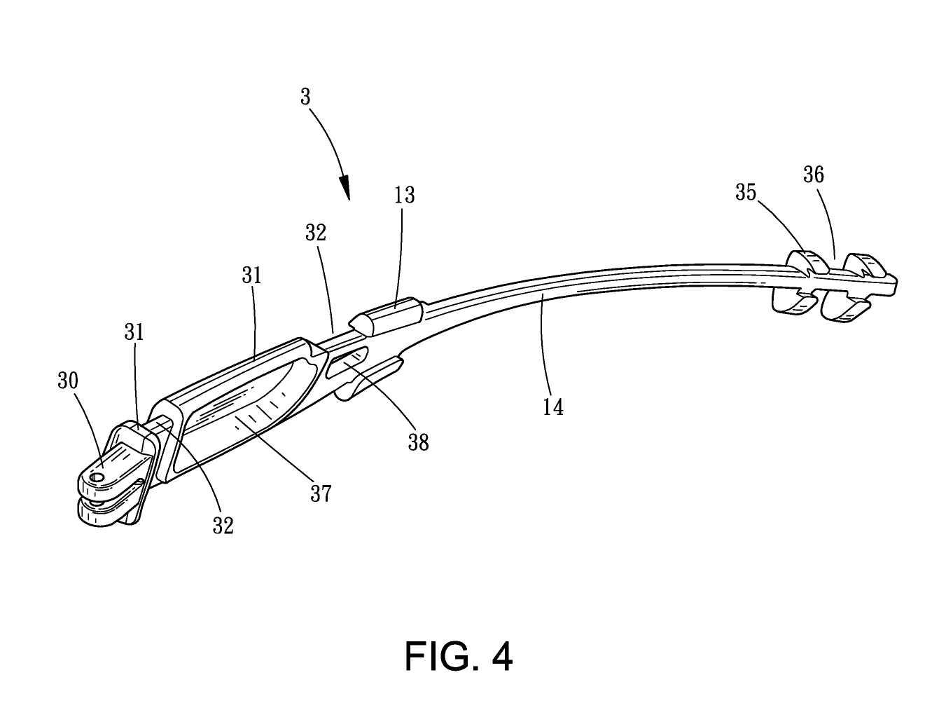

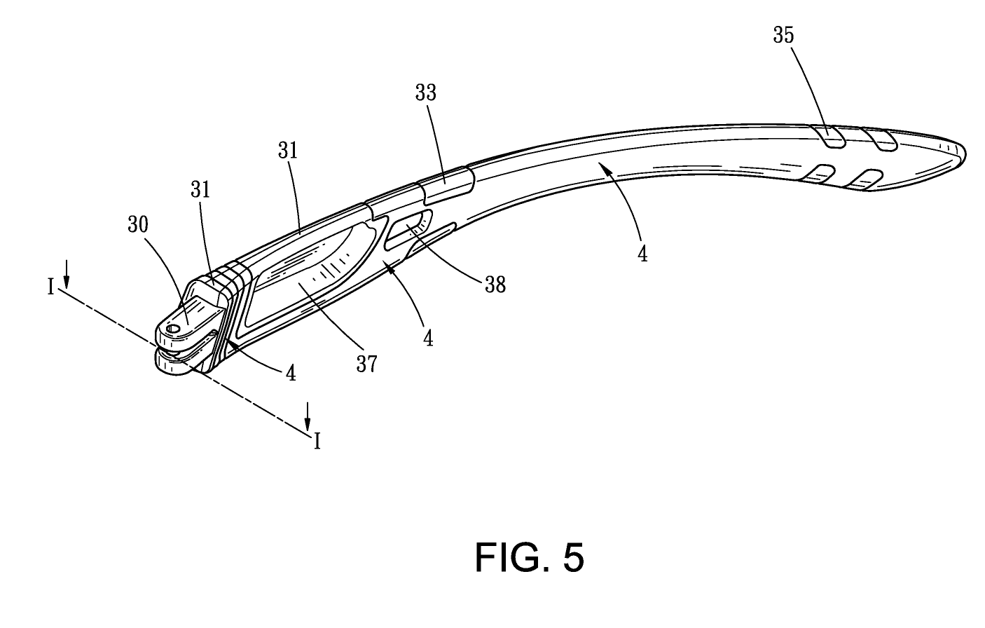

A second preferred embodiment of an eyeglass temple of composite material in the present invention, as shown in FIGS. 4 and 5, mainly includes a temple body 3 and non-rigid material 4 combined together. The temple body 3 made of non-rigid material like PC and formed integrally is provided thereon with a pivotal seat 30, molding projections 31, recesses 32 and molding ornamental pieces 33. An elongated tail 34 is connected with the rear section of the molding ornamental pieces 33, and plural annular projections 35 and an annular groove 36 are disposed at the end of the elongated tail 34. Further, one molding projection 31 is formed with a recessed groove 37, and a through hole 38 is bored under the recesss 32. The non-rigid material 4 is rubber, silica gel or the like.

In manufacturing, the non-rigid material 4 is injection molded on the recesses 32, the elongated tail 34 and the annular groove 36 to make up a composite-material eyeglass temple, which has good coverage and practicability and further is able to show visual perception of different materials.

As can be known from the above description, this invention has the following characteristics and advantages:

1. The eyeglass temple of composite material of this invention is to have the aluminum-alloy temple body 1 partially coated with the non-metallic material 2, having practicability and integral esthetic appearance.

2. The plasticity of the aluminum-alloy temple body 1 of this invention enables a user to wear the eyeglasses with great comfort.

3. The integrally formed pivotal seat 10 of the eyeglass temple of composite material of this invention can be directly assembled with the eyeglass frame, needless to provide any extra pivotal seat.

4. The aluminum-alloy elongated tail 14 of the eyeglass temple of this invention can be bent into a better angle suitable for a user to wear the glasses, thus offering a better effect in use.

While the preferred embodiments of the invention have been described above, it will be recognized and understood that various modifications may be made therein and the appended claims are intended to cover all such modifications that may fall within the spirit and scope of the invention.

What is claimed is:

1. An eyeglass temple of composite material comprising a temple body and non-metallic material combined together, said temple body made of aluminum-alloy and formed integrally, said temple body having a front end provided with a pivotal seat, a plurality of molding projections and recesses provided at a rear side of said pivotal seat, said temple body having another side extending to form an elongated tail, said non-metallic material injected and coated on both said recesses and said elongated tail, said molding projections and said non-metallic material forming another kind of three-dimensional effect and practicability.

2. The eyeglass temple of composite material as claimed in claim 1, wherein said temple body is specially processed to let said temple body able to prevent rust and formed with a shining surface.

3. The eyeglass temple of composite material as claimed in claim 1, wherein said temple body and said non-metallic material are injection molded together, said temple body and said non-metallic material impossible to be separated.

4. The eyeglass temple of composite material as claimed in claim 1, wherein said elongated tail of said temple body has an end provided with an annular groove, said non-material injection molded on said annular groove to enable said non-metallic material to be combined with said temple body comparatively tightly.

5. The eyeglass temple of composite material as claimed in claim 1, wherein said temple body is formed by a mold.

6. An eyeglass temple of composite material comprising a temple body and non-metallic material combined together, said temple body formed integrally and having a front end provided with a pivotal seat, said pivotal seat having a rear side provided with molding projections and recesses, said temple body having another side extending to form an elongated tail, said elongated tail provided with an annular groove, said non-metallic material injection molded on said recesses and said elongated tail and said annular groove of said temple body, letting said molding projections and said non-metallic material form another kind of three-dimensional effect and practicability.
